(19) United States
(12) Patent Application Publication
(10) Pub. No.: US 2018/0014067 A1
(43) Pub. Date: Jan. 11, 2018

(54) SYSTEMS AND METHODS FOR ANALYZING USER INTERACTIONS WITH VIDEO CONTENT

(71) Applicant: Wistia, Inc., Cambridge, MA (US)

(72) Inventors: Brendan Schwartz, Cambridge, MA (US); Marshall Moutenot, Somerville, MA (US); Joe Ringenberg, Boston, MA (US); Molly Wolfberg, Cambridge, MA (US); Joel Schwartz, Providence, RI (US); Liat Werber, Somerville, MA (US)

(21) Appl. No.: 15/206,934

(22) Filed: Jul. 11, 2016

(51) Int. Cl. H04N 21/442; H04N 21/441; H04N 5/265; H04N 21/422; H04N 21/414; H04N 21/81; H04N 21/44

(52) U.S. Cl. CPC H04N 21/44218; H04N 21/816; H04N 21/8146; H04N 21/441; H04N 21/44008; H04N 21/42222; H04N 21/41407; H04N 5/265; G06T 2207/10016

(57) ABSTRACT

Computer-implemented methods and systems are presented for creating, displaying and interacting with a space-time focal density map indicating aggregate user engagement within video contenbased on user-initiated movements of a display device. User engagement may be tracked and stored at an individual user level as well as aggregated into the statistical compilation. The engagement data may be presented as a visual layer overlaid with the video content against which the engagement data was collected, effectively displaying a temporal interest heat map over the video content. A graphical representation of the engagement data may be displayed along with the heat map that includes axes representing a spatial dimension (e.g., degrees or radians from the center of the video) and a temporal dimension (e.g., the top of the graph represents the start of the video, and the bottom the end).

### FIELD OF THE INVENTION

The present disclosure relates generally to capturing user responses to spatial video content and, more particularly, to systems and methods for automatically creating and displaying a focal point density map to indicate areas of interest in space and time within the video content.

### BACKGROUND

Over the past decade there has been an exponential growth in the prevalence of streaming media in the lives of the general public. Users frequently view video content on various websites or within mobile applications. The video content may be user generated (e.g., videos captured from user devices and posted on social networking sites such as Facebook and Snapchat), professional published content such as television and movies on sites such as Hulu, Netflix, and YouTube, or commercial content created for brands and companies published on their respective website or within an application. Existing forms of interactive video players allow a viewer to make choices on how to proceed through a video by playing the video, pausing the video, restarting the video, or exiting from the video at any point in time. Applications exist that can capture these temporal events as they relate to the video generally. Spatial video is a field with growing adoption over only the last few years. This new media is rendered in a sphere around a viewer, who may move and manipulate their point of view as the video plays. This format has new opportunity for interaction, and information about where viewers' focused greatly benefits the creators of such content. Current techniques do not capture a user's spatial focal point over time.

### SUMMARY

Systems and methods are presented for creating a spatially coordinated, temporally synchronized focal point density map indicating the elements of focus within video content. The focal point density map may, in certain instances, represent an amplitude of user engagement with the video content, which can be displayed in various manners to indicate elements within the content that attract user attention, where in space the user is looking, and when that attention span starts, wanes, stops, or transitions to other elements. User engagement may be tracked and stored at an individual user level as well as aggregated. The engagement data may be presented as a visual layer overlaid with the video content against which the engagement data was collected, effectively displaying a temporal interest heat map over the video content. Separately, or in addition to the heat map overlay, a graphical representation of the engagement data may be displayed. For example, an engagement map may include a horizontal axis representing the spatial dimension (e.g., degrees or radians from the center of the video) and the vertical axis representing the temporal dimension (e.g., the top of the graph represents the start of the video, and the bottom the end).

Therefore, in one aspect, a computer-implemented method for measuring and displaying user engagement with video content is provided. Orientation data is received from user devices as users of each device view video content on each respective user device, and, based on the orientation data, determining each user's focal point within the video either periodically or when a change in the focal point has occurred. A focal point density map is created for the video content, wherein the focal point density map visually indicates an aggregated temporal and spatial distribution of the users' focal points, and a display of the focal point density map and the associated video content is presented, thereby indicating elements of interest within the video content. The video may be standard form and resolution, panoramic, high-definition, and/or three-dimensional, and may contain audio tracks.

In some embodiments, the device orientation data includes accelerometer data, gyroscope data, and/or GPS data, each received from devices within the user devices. In embodiments in which the video is viewed using a desktop or other stationary device, mouse or pointer events may be used to determine orientation data. In some cases, a field of view of the video content is adjusted in response to the orientation data such that the focal point is substantially centered on a viewing screen of the user device. The orientation data can be stored such that the orientation data comprises a temporal data element, a spatial data element, a user identifier and a video content identifier, among other metadata describing the video content itself.

The display including the focal point density map and the associated video content may be presented as a layered display such that the density map is overlaid on the video content (which, if panoramic, may be presented as an equirectangular projection of the panoramic video content) and such that the focal point density map and video content are temporally and spatially synchronized. In some instances the video content may be spherical, allowing for both horizontal and vertical movements. The focal point density map may substantially transparent, thereby facilitating the viewing of elements within the video content behind the focal point density map. In some instances, the aggregate spatial distribution of the focal point density map is displayed as a gradient, such as a color gradient, a shading gradient and/or a transparency gradient.

The display may be presented in conjunction with a set of player controls (within or adjacent to the display), whereby the player controls facilitate manual manipulation of the video content and the focal point density map by a user. The aggregated temporal and aggregate spatial distribution of users' focal points can, in some embodiments, be filtered such that the focal point density map comprises a subset of the focal points based, for example, on user attributes and/or device attributes.

In another aspect, a system for displaying and measuring viewer engagement among elements of video content is provided. The system includes one or more computers programmed to perform certain operations, including receiving user device orientation data from user devices as users of each device views video content on each respective user device and periodically determining from the user device orientation data each user's focal point within the video. The computers are programmed to automatically create a focal point density map for the video content, wherein the focal point density map visually indicates an aggregated temporal and spatial distribution of users' focal points and to present a display of the focal point density map and the associated video content, thereby indicating elements of interest within the video content.

In some embodiments, the device orientation data includes accelerometer data, gyroscope data, and/or GPS data, each received from devices within the user devices. In some cases, a field of view of the video content is adjusted in response to the orientation data such that the focal point is substantially centered on a viewing screen of the user device. The orientation data can be stored such that the orientation data comprises a temporal data element, a spatial data element, a user identifier and a video content identifier, among other metadata describing the video content itself.

The display including the focal point density map and the associated video content may be presented as a layered display such that the density map is overlaid on the video content (which, if panoramic, may be presented as an equirectangular projection of the panoramic video content)and such that the focal point density map and video content are temporally and spatially synchronized. In some instances the video content may be spherical, allowing for both horizontal and vertical movements. The focal point density map may substantially transparent, thereby facilitating the viewing of elements within the video content behind the focal point density map. In some instances, the statistical spatial distribution of the focal point density map is displayed as a gradient, such as a color gradient, a shading gradient and/or a transparency gradient.

The display may be presented in conjunction with a set of player controls (within or adjacent to the display), whereby the player controls facilitate manual manipulation of the video content and the focal point density map by a user. The aggregated temporal and aggregate spatial distribution of users' focal points can, in some embodiments, be filtered such that the focal point density map comprises a subset of the focal points based, for example, on user attributes and/or device attributes.

Other aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 is a block diagram of an example system for generating and viewing user engagement data as related to video content in accordance with various embodiments of the invention.

FIG. 2a is an example of video content that may be viewed on a user device.

FIG. 2b illustrates the video content of FIG. 2a as displayed on an exemplary user device in accordance with various embodiments of the invention.

FIG. 3 illustrates the user device of FIG. 2b being subjected to one or more user orientation commands in accordance with various embodiments of the invention.

FIG. 4 illustrates exemplary video content comprised of various elements annotated with a focal point heat map in accordance with various embodiments of the invention.

FIG. 5a illustrates the annotated video content of FIG. 4 coupled with a spatial and temporal representation of user engagement in accordance with various embodiments of the invention.

FIG. 5b illustrates the annotated video content of FIG. 5a annotated with a linear representation of user engagement the annotated video content.

FIG. 6 illustrates the annotated video content of FIG. 5a in conjunction with user-specific user engagement data the annotated video content.

FIG. 7 is a block diagram of the system components that may be used to implement various embodiments of the invention.

### DETAILED DESCRIPTION

Described herein are various implementations of methods and supporting systems for capturing, measuring, analyzing and displaying users' engagement with visual (still and moving video) content on user display devices. As used herein, video content may refer to any form of visually presented information, data, and images, including still images, moving pictures, data maps, virtual reality landscapes, video games, etc.

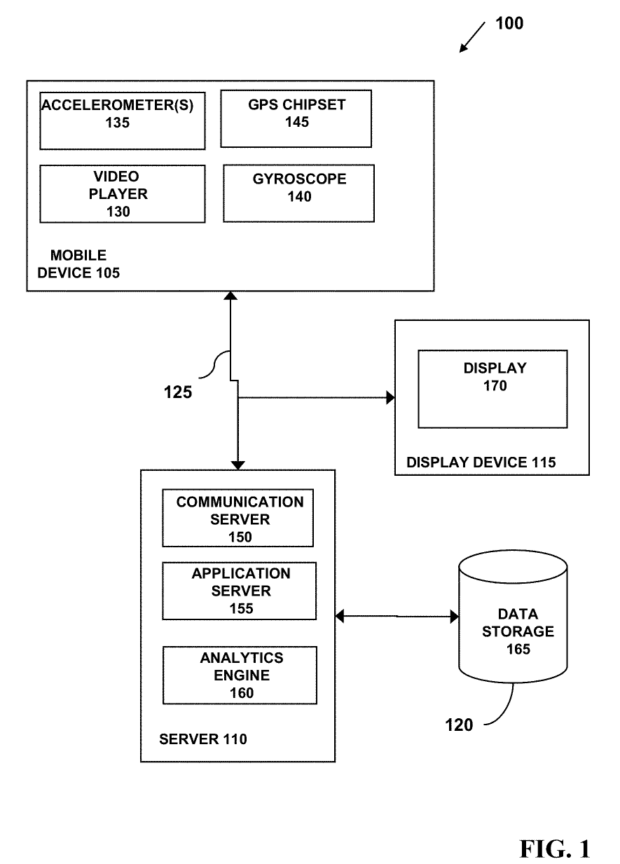

FIG. 1 illustrates an exemplary operating environment 100 in which a mobile device 105 (e.g., a mobile telephone, personal digital assistant, smartphone, or other handheld device having processing and display capabilities such as an iPhone or Android-based device) may be used to download, view and interact with content. The content may be any visual or audio/video media including still images, videos and the like. The format of the content may be standard definition, high-definition, compressed, and any size or aspect (e.g., panoramic, etc.). Mobile device 105 may be operatively connected to a server 110 on which one or more application components may be stored and/or executed to implement the techniques described herein. In addition to the mobile device 105 and server 110, a display device 115 may be used to present numeric, textual and/or graphical results of the application processes. The display device 115 may be a separate, stand-alone physical device (such as a laptop, desktop or other computing device) or in some cases it may be an integral component of the server 110 or the mobile device 105. In some implementations, a separate data storage server 120 may be used to store the content being analyzed, the results of the user engagement analysis, or both. Like the display device 115, the data storage device 120 may be physically distinct from the server 110 or a virtual component of the server 110.

The mobile device 105, server 110, display device 115 and data storage server 120 communicate with each other (as well as other devices and data sources) via a network 125. The network communication may take place via any media such as standard and/or cellular telephone lines, LAN or WAN links (e.g., T1, T3, 56 kb, X.25), broadband connections (ISDN, Frame Relay, ATM), wireless links, and so on. Preferably, the network 125 can carry TCP/IP protocol communications, and HTTP/HTTPS requests made by the mobile device and the connection between the mobile device 105 and the server 110 can be communicated over such networks. In some implementations, the network includes various cellular data networks such as 2G, 3G, 4G, and others. The type of network is not limited, however, and any suitable network may be used. Typical examples of networks that can serve as the communications network 125 include a wireless or wired Ethernet-based intranet, a local or wide-area network (LAN or WAN), and/or the global communications network known as the Internet, which may accommodate many different communications media and protocols.

The mobile device 105 may include various functional components that facilitate the display and analysis of content on the device 105. For example, the mobile device 105 may include a vide player component 130. The video player component 130 receives content via the network 125 or from stored memory of the device 105 and renders the content in response to user commands. In some instance the video player 130 may be native to the device 105, whereas in other instances the video player 130 may be a specially-designed application installed on the device 105 by the user. The content rendered by the video player may be any form, including still photographs, panoramic photos, video, three-dimensional video, high-definition video, etc.

The mobile device 105 may also include one or more components that sense and provide data representing the location, orientation and/or movement of the device 105. For example, the mobile device 105 may include one or more accelerometers 135. For example, in certain mobile devices, three accelerometers 135 are used—one for each of the x, y and z axis. Each accelerometer 135 measures changes in velocity over time along a linear path. Combining readings from the three accelerometers 135 indicates device movement in any direction and the device's current orientation. The device 105 may also include a gyroscope 140 to measure the rate of rotation about each axis. In addition to the motion sensing capabilities provided by the accelerometer 135 and gyroscope 140, a GPS chipset 145 may be used to indicate a physical location of the device 105. Together, data gathered from the accelerometer 135 and gyroscope 140 indicates the rate and direction of movement of the device 105 in space, and data from the GPS chipset may provide location-based information such that applications operating on the device 105 may receive and respond to such information, as well as report such information to the server 110.

The server 110 many include various functional components, including, for example, a communications server 150 and an application server 155. The communication server provides the conduit through which requests for data and processing are received from the mobile device 105, as well as interaction with other servers that may provide additional content and user engagement data. The application server 155 stores and executes the primary programming instructions for facilitating the functions executed on the server 130. In some instances, the server 110 also includes an analytics engine 160 that analyzes user engagement data and provides historical, statistical and predictive breakdowns or aggregated summaries of the data. Content and data describing the content, user profiles, and user engagement data may be stored in a data storage application 165 on the data storage device 125. In some instances, data representing user orientation and interest include a temporal element (e.g. a timestamp and/or time range), a spatial element (such as an angular field of view and/or a focal point location), a user identifier to identify the individual viewing the content, and a content identifier to uniquely identify the content being viewed.

Once the application server 155 and the analytics engine 160 receive, analyze and format user engagement data, one or more displays 170 may be presented to a user who can view, interact with and otherwise manipulate the display 170 using keyboard commands, mouse movements, touchscreen commands and other means of command inputs.

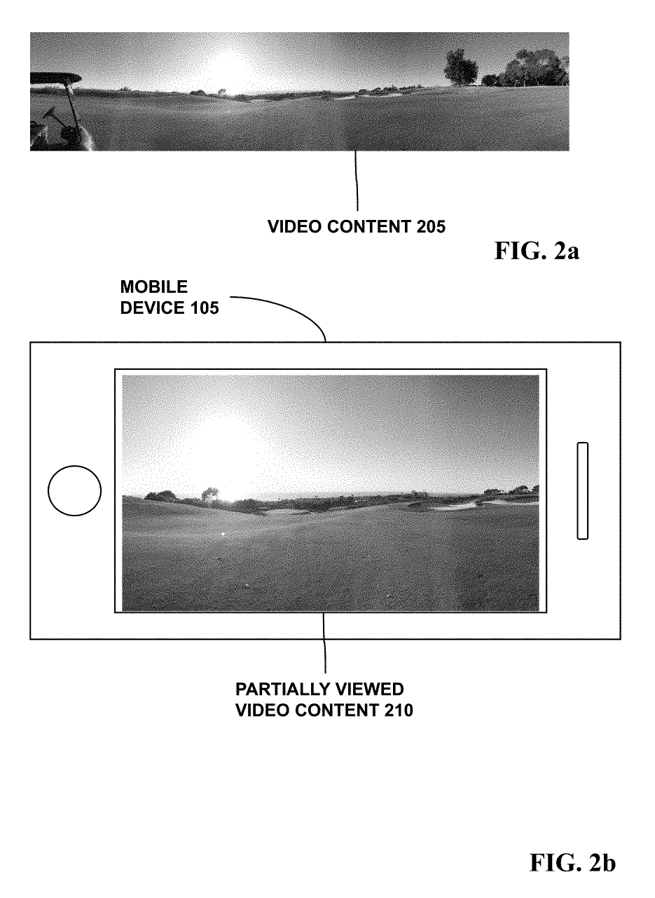

FIG. 2a illustrates one embodiment of content 205 that may be viewed on the device 105. In this instance, the content 205 comprises panoramic or spherical video content such that the field of view of the content may not fit within a display of a mobile device 105 as indicated in FIG. 2b, where only partially viewed video content 210 is seen. For example, the field of view of the video content 205 may be a 360-degree panorama, thus requiring users to manipulate the content to change the field of view (which may be only 120 degrees). Moreover, the panoramic video content 205 may include many content elements distributed spatially and/or temporally throughout the content such that at various times (or focused at a particular focal point) a viewer may not see a particular element of interest. For example, video content 205 includes a golf cart, a sunset, a green area surrounded by sand traps, and a collection of trees. Each of these elements is spatially distributed such that when viewing the partially displayed content 210 some of the elements may be “off screen.” In addition, as the video content is presented to the user, the field of view may change and/or elements may enter the field of view, such that additional elements—a golfer, the ocean, or an animal—may appear, thus enticing the user to change their point of interest and/or focal point.

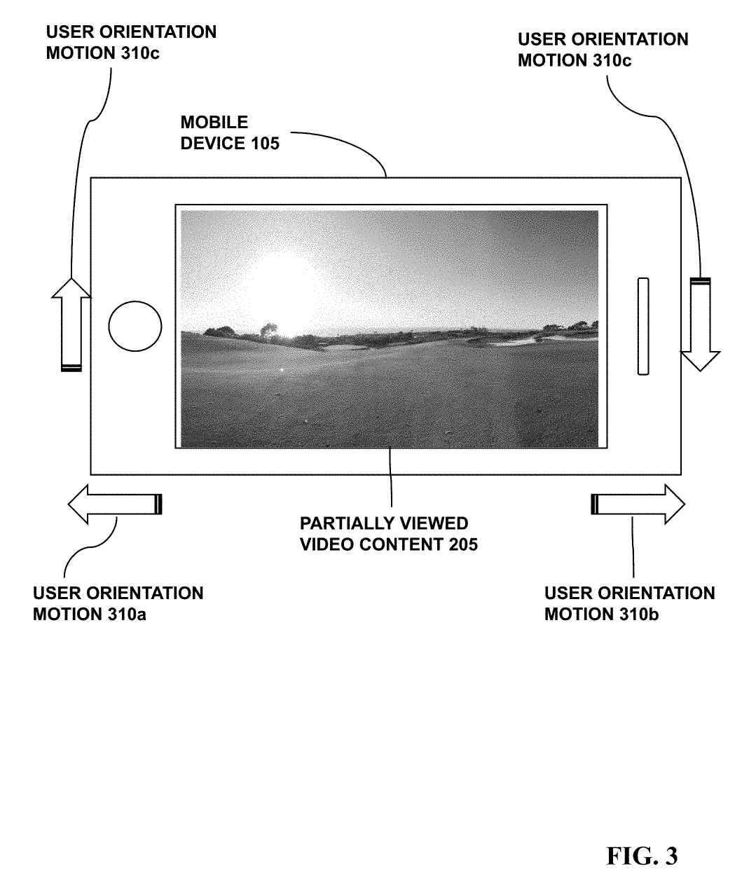

Referring to FIG. 3, the mobile device 105 may be subject to user-initiated orientation adjustments that can affect how content 205 is played and displayed on the device 105. For example, the user may rotate the device to the left (represented by user orientation motion 310a), and as a result the content pans to the left. Similarly, the user may rotate the device to the right (represented by user orientation motion 310b), and as a result the content pans to the right. The user may also tilt the device 105 up or down, or use finger gestures (pinching, swiping, etc.) to manipulate the content such that the field of view widens, narrows, moves to the left, right, up or down. With each user initiated manipulation, the components within the device 105 (accelerometers, gyroscopes, etc.) output user orientation data which can be captured using various programming methods to indicate the direction and extent the user has manipulated the device 105, and, by extension, the effect such movement has on the display of the content 205.

As an example only, implementations using an Apple iPhone as the device 105 utilize a Core Motion framework in which device motion events are represented by three data objects, each encapsulating one or more measurements. A CMAccelerometerData object captures the acceleration along each of the spatial axes, A CMGyroData object captures the rate of rotation around each of the three spatial axes, and A CMDeviceMotion object encapsulates several different measurements, including altitude and more useful measurements of rotation rate and acceleration. The CMMotionManager class is the central access point for Core Motion. Creating an instance of the class facilitates the specification of an update interval, requests that updates start, and handles motion events as they are delivered. All of the data-encapsulating classes of Core Motion are subclasses of CMLogItem, which defines a timestamp so that motion data can be tagged with a time and stored in the data storage device as described above. Motion data may be captured using a “pull” technique, in which an application periodically samples the most recent measurement of motion data, or “push” in which an application specifies an update interval and implements a block for handling the data. The Core Motion framework then delivers each update to the block, which can execute as a task in the operation queue.

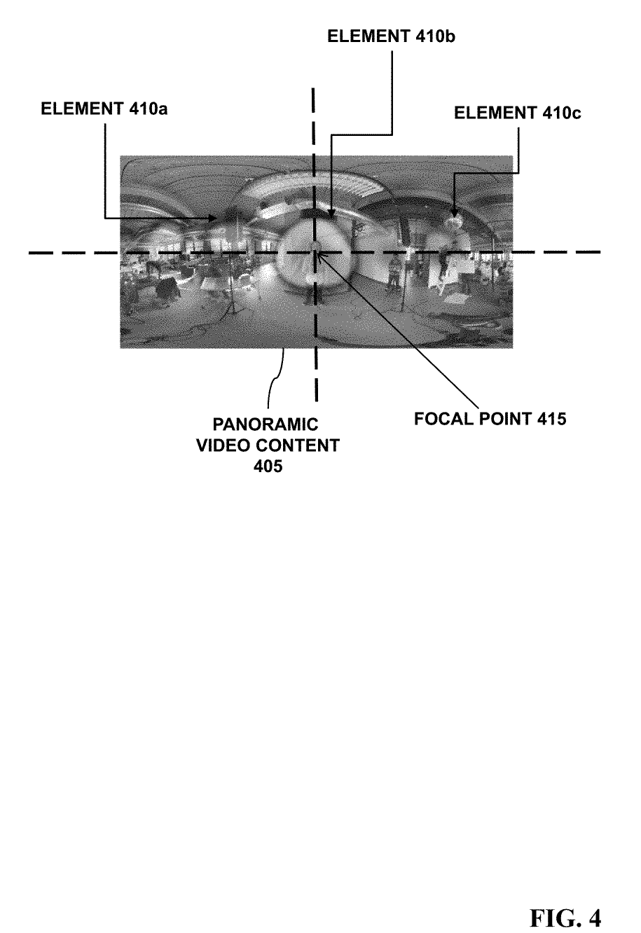

Referring to FIG. 4, a panoramic video content 405 includes numerous elements—such as a speaker stand 410a, a speaking individual 410b and an individual on a ladder 410c (referred to generally as 410). While only three elements 410 are indicated, there may be any number of elements. Based on the user orientation data captured during playback of the content, a focal point 415 can be determined. The focal point 415 may be identified using various datapoints, including an angular location within the field of view (e.g., degrees from center) in the horizontal and or vertical directions, as well as temporal (e.g., a timestamp within the content, such as the number of minutes/seconds the measurement is taken). In some cases, the location of elements 410 may also be known and identified by locations within the content 405 such that a focal point at a certain location can be generally associated with an element 410. This may facilitate an indication that at time t, the user was generally focused on element 410b. As this data is captured for numerous users, a statistical distribution of focal points may be collected and calculated indicating which elements and/or areas within the content represent areas of interest among the users.

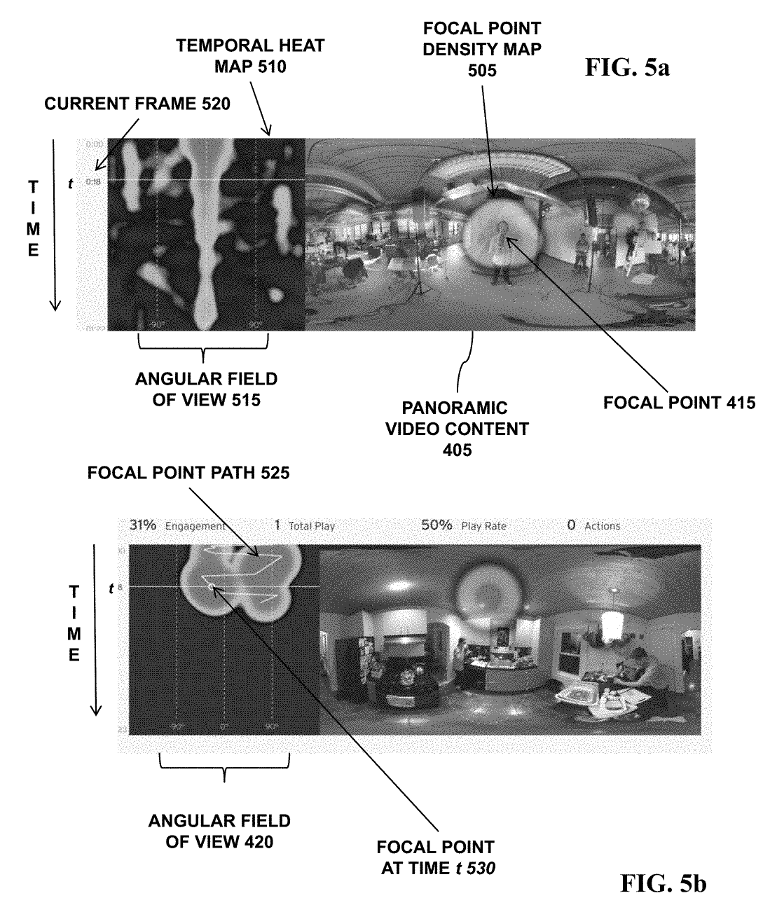

FIG. 5a illustrates one embodiment of a display comprising the video content 405 and a super-imposed focal point density map 505 indicating the statistical distribution of users' focal points as they view the content 405. The density map 505 may include a color or grey-scale gradient indicating the density of the data for a particular area (e.g., pixel or group of pixels) or element within the content. For example, a color gradient may be displayed as a circular continuum wherein the outer area or bands of the map are displayed as “cool” or “light” or use a color from one end of the visual spectrum such as violet, and as the density of the focal points increases, the gradient changes to brighter color(s) or the other end of the visual spectrum such as red or orange, representing the most frequently viewed element or focal point. Some display options may include only black and white displays, and in such cases the gradient may be displayed as an increasing or decreasing grey-scale map. Other methods of representing the aggregate density of the focal point data, such as symbols (e.g., X's for highly viewed areas) may also be used.

In some embodiments, the density map 505 may be uniform along the vertical axis, if, for example, the users' focal point is measured only along the horizontal axis. In other cases, the density map 505 may include a non-inform gradient where the users' focal point is measured along both the horizontal and vertical axes. In some implementations, the data may be structured and stores such that one dimension may be held constant while another changes.

As described above, the focal point data may be measured periodically while users are engaged with the content, thereby facilitating a temporal representation of the heat map. Specifically, the heat map display can indicate, over time, the relative engagement or interest in elements within the content. As the content is played or displayed, the density map changes to indicate users' interest at that point in the content. In some cases, the frequency with which the focal point data measures users' interest matches the frame rate of the content, thus showing the density map for each particular frame of the content.

Still referring to FIG. 5a, a secondary display indicates a temporal density map 510 such that one axis (the x axis as shown) indicates the angular field of view 515 and the other axis (they axis as shown) indicates time. The angular field of view 515 may match or be a subset of the field of view of the original content. For example, if the content is a 360-degree spherical video, the x axis may range from −180 degrees to +180 degrees and be displayed in an equirectangular format and the y axis may range from −90 degrees to +90 degrees. The current frame being displayed from the video content may be indicated in the secondary display 510 as a line at time t such that the cross-section of the density map in the secondary display of the content matches the current frame 520 being displayed in the primary display. Moreover, the cross-section of the density map displayed in the secondary display matches the density map in the primary display. As such, the secondary display provides a complete, time-scaled indication of users' focal points and areas of primary interest throughout the entire content. This allows viewers of the display to identify, for example, when users typically change focus, or which elements in the content are distracting or capturing interest.

Referring now to FIG. 5b, a focal point path 525 may be added to the secondary display. In some embodiments, the focal point path 525 may indicate the central focal point throughout the temporal density map such that the path indicates the exact (or near-exact) focal point, effectively indicating where the statistical map is most dense. The secondary display may also include a point representation of the most prominent focal point at time t 530.

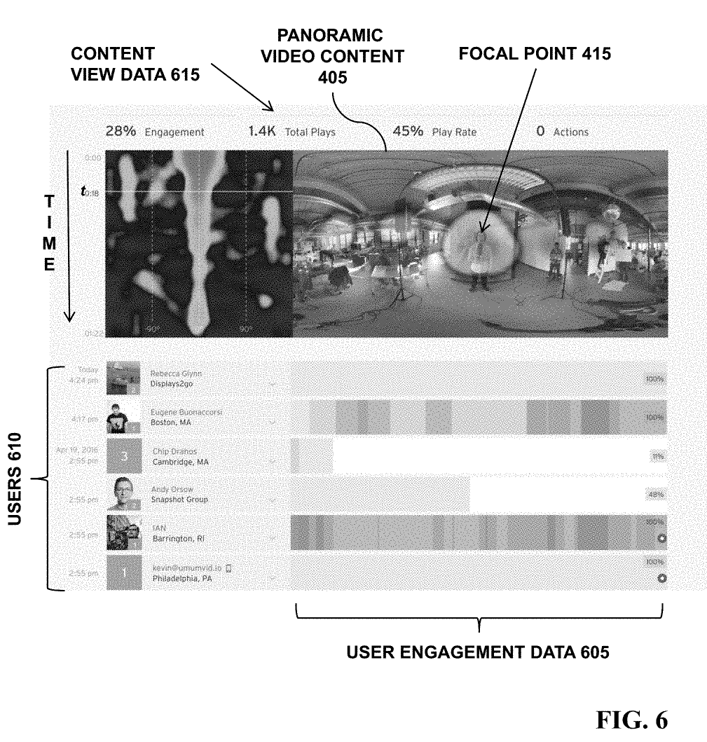

As described above, the focal point density map comprises an aggregation of user-based focal point data collected over time and across a potentially wide variety of users (e.g., ages, locations, etc.). FIG. 6 illustrates how user engagement data 605 collected from specific users 610 may be used to filter the data used to create the focal point density map, the secondary temporal display, or both. For example, users 610 may be filtered by age, sex, location, date viewed, type of device on which the content was being viewed, or other metadata collected regarding the user, the user's device and/or the user's interaction with the content. The user engagement data 605 may also be color-coded or grey-scaled to indicate particular times during the content when they interact with their viewing device to manipulate the orientation of the device, thereby changing their focal point. Other content data such as total views, engagement percentage (% of users that view the content up through a specific point), and play rate may be added to the display to provide additional information about the content.

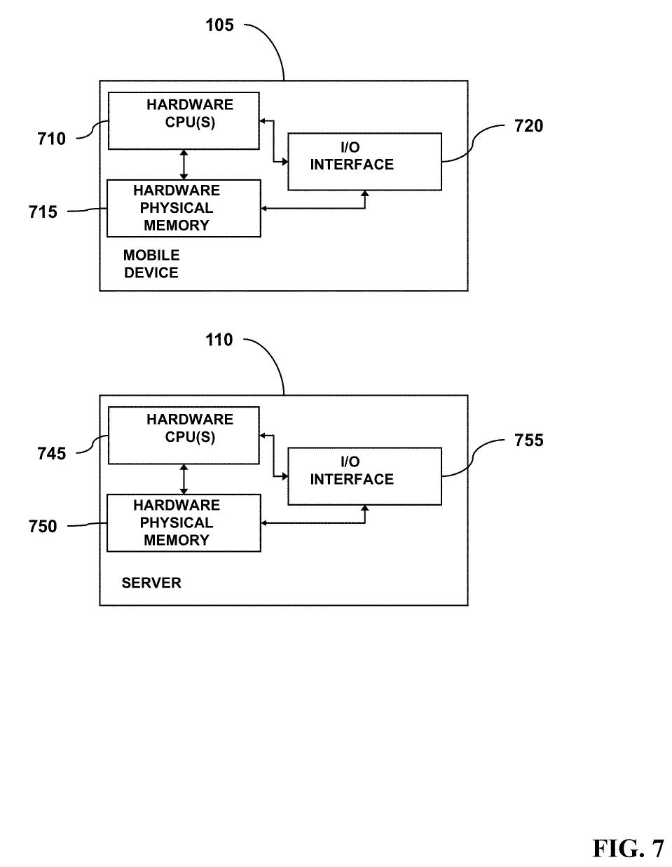

Mobile device 105 and server(s) 110 may be implemented in any suitable way. FIG. 7 illustrates an exemplary architecture for a mobile device 105 and a server 110 that may be used in some embodiments. The mobile device 105 may include hardware central processing unit(s) (CPU) 710, operatively connected to hardware/physical memory 715 and input/output (I/O) interface 720. Exemplary server 110 similarly comprises hardware CPU(s) 745, operatively connected to hardware/physical memory 750 and input/output (I/O) interface 755. Hardware/physical memory may include volatile and/or non-volatile memory. The memory may store one or more instructions to program the CPU to perform any of the functions described herein. The memory may also store one or more application programs.

Exemplary mobile device 105 and exemplary server 110 may have one or more input and output devices. These devices can be used, among other things, to present a user interface and/or communicate (e.g., via a network) with other devices or computers. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Although examples provided herein may have described the servers as residing on separate computers, it should be appreciated that the functionality of these components can be implemented on a single computer, or on any larger number of computers in a distributed fashion.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only. The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In some embodiments the functions may be implemented as computer instructions stored in portions of a computer's random access memory to provide control logic that affects the processes described above. In such an embodiment, the program may be written in any one of a number of high-level languages, such as FORTRAN, PASCAL, C, C++, C#, Java, javascript, Tcl, or BASIC. Further, the program can be written in a script, macro, or functionality embedded in commercially available software, such as EXCEL or VISUAL BASIC. Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

Although the systems and methods described herein relate primarily to audio and video playback, the invention is equally applicable to various streaming and non-streaming media, including animation, video games, interactive media, and other forms of content usable in conjunction with the present systems and methods. Further, there can be more than one audio, video, and/or other media content stream played in synchronization with other streams. Streaming media can include, for example, multimedia content that is continuously presented to a user while it is received from a content delivery source, such as a remote video server. If a source media file is in a format that cannot be streamed and/or does not allow for seamless connections between segments, the media file can be transcoded or converted into a format supporting streaming and/or seamless transitions.

While various implementations of the present invention have been described herein, it should be understood that they have been presented by example only. Where methods and steps described above indicate certain events occurring in certain order, those of ordinary skill in the art having the benefit of this disclosure would recognize that the ordering of certain steps can be modified and that such modifications are in accordance with the given variations. For example, although various implementations have been described as having particular features and/or combinations of components, other implementations are possible having any combination or sub-combination of any features and/or components from any of the implementations described herein.

1. A computer-implemented method for measuring viewer engagement among elements of video content, the method comprising:
receiving user device orientation data from a plurality of user devices as users of each device views video content on each respective user device;
determining from the user device orientation data each user's focal point within the video;
automatically creating a temporal density map for the video content, wherein the temporal density map visually indicates users' focal points throughout the video content as a first density map comprising an aggregated statistical spatial distribution of users' focal points and a line indicating a central focal point through the first density map;
automatically creating a second focal point density map for the video content, wherein the second focal point density map visually indicates an aggregated spatial distribution of users' focal points at a time t and wherein the second focal point map represents a cross-section of the first density map of the temporal density map at time t within the span; and
presenting a display comprising the focal point density map, the temporal density map, and the associated video content, thereby indicating elements of interest within the video content.

2. The method of claim 1, wherein the device orientation data comprises data received from an accelerometer within the user devices.

3. The method of claim 2 wherein a field of view of the video content is adjusted in response to the orientation data such that the focal point is centered on a viewing screen of the user device.

4. The method of claim 1, further comprising storing the orientation data in a database such that the orientation data comprises a temporal data element, a spatial data element, a user identifier and a video content identifier.

5. The method of claim 1, wherein the display comprising the second focal point density map and the associated video content comprises a layered display such that the second focal point density map is overlaid on the video content such that the second focal point density map and video content are temporally and spatially synchronized.

6. The method of claim 5 wherein the video content comprises a panoramic view.

7. The method of claim 6 wherein the second focal point density map is overlaid on an equirectangular projection of the panoramic video content.

8. The method of claim 5, wherein the second focal point density map is transparent, thereby allowing the viewing of elements within the video content behind the second focal point density map.

9. The method of claim 8, wherein the statistical spatial distribution of the focal point density map is displayed as a gradient.

10. The method of claim 9, wherein the gradient comprises one or more of a color gradient, a shading gradient or a transparency gradient.

11. The method of claim 5 further comprising providing a set of player controls within the display, whereby the player controls allow manual manipulation of the video content and of the second focal point density map.

12. The method of claim 1, further comprising filtering the aggregated temporal and statistical spatial distribution of users' focal points such that the second focal point density map comprises a subset of the focal points.

13. The method of claim 12, wherein the filtering is based on one or more user attributes.

14. The method of claim 12, wherein the filtering is based on one or more device attributes.

15. A system for measuring viewer engagement among elements of video content, the system comprising:
at least one memory device storing computer-readable instructions; and
at least one data processing device operable to execute the computer-readable instructions to perform operations including:
receiving user device orientation data from a plurality of user devices as users of each device views video content on each respective user device;
determining from the user device orientation data each user's focal point within the video;
automatically creating a temporal density map for the video content, wherein the temporal density map visually indicates users' focal points throughout the video content as a first density map comprising an aggregated statistical spatial distribution of users' focal points and a line indicating a central focal point through the first density map;
automatically creating a second focal point density map for the video content, wherein the second focal point density map visually indicates an aggregated spatial distribution of users' focal points at a time t and wherein the second focal point map represents a cross-section of the first density map of the temporal density map at time t within the span; and
presenting a display comprising the focal point density map, the temporal density map, and the associated video content, thereby indicating elements of intere

16. The system of claim 15, wherein the device orientation data comprises data received from an accelerometer within the user devices.

17. The system of claim 16 wherein a field of view of the video content is adjusted in response to the orientation data such that the focal point is centered on a viewing screen of the user device.

18. The system of claim 15, further comprising storing the orientation data in a database such that the orientation data comprises a temporal data element, a spatial data element, a user identifier and a video content identifier.

19. The system of claim 15, wherein the display comprising the second focal point density map and the associated video content comprises a layered display such that the second focal point density map is overlaid on the video content such that the second focal point density map and video content are temporally and spatially synchronized.

20. The system of claim 19 wherein the video content comprises a panoramic view.

21. The system of claim 20 wherein the second focal point density map is overlaid on an equirectangular projection of the panoramic video content.

22. The system of claim 19, wherein the second focal point density map is transparent, thereby allowing the viewing of elements within the video content behind the second focal point density map.

23. The system of claim 22, wherein the statistical spatial distribution of the second focal point density map is displayed as a gradient.

24. The system of claim 23, wherein the gradient comprises one or more of a color gradient, a shading gradient or a transparency gradient.

25. The system of claim 19 further comprising providing a set of player controls within the display, whereby the player controls allow manual manipulation of the video content and of the second focal point density map.

26. The system of claim 15, further comprising filtering the aggregated temporal and statistical spatial distribution of users' focal points such that the second focal point density map comprises a subset of the focal points.

27. The system of claim 26, wherein the filtering is based on one or more user attributes.

28. The system of claim 26, wherein the filtering is based on one or more device attributes.
